(19) United States
(12) Patent Application Publication
(10) Pub. No.: US 2012/0177890 A1
(43) Pub. Date: Jul. 12, 2012

(54) OPTICAL FILM AND MANUFACTURING METHOD THEREOF

(76) Inventors: Chang-Chih SUNG, Taoyuan County (TW); Tsang-Feng Ho, Taoyuan County (TW)

(21) Appl. No.: 12/987,164

(22) Filed: Jan. 10, 2011

(51) Int. Cl. B32B 3/30; B05D 5/06

(52) U.S. Cl. 428/172; 427/510

(57) ABSTRACT

An optical film and manufacturing method thereof are provided. The optical film includes a main body and a plurality of first microstructures. A plurality of micro bubbles is disposed inside the main body. The first microstructures are disposed on one side of the main body. The optical film can avoid light having smaller or reduced incident angle from being reflected by the first microstructures, therefore, as a result, the illumination brightness using the optical film can be enhanced.

### FIELD OF INVENTION

The present invention relates to an optical film and manufacturing method thereof, especially relates to an optical film used in the liquid crystal display and manufacturing thereof.

### BACKGROUND OF THE INVENTION

In recent years, the traditional Cathode ray tube display, hereinafter referred to as CRT display, is gradually replaced by Liquid crystal display, hereinafter referred to as LCD display. One major reason for this trend is because that the radiation emitting from the LCD display is far less than the CRT display, and that the cost of the LCD display is significantly reduced. In general, the LCD display includes a backlight assembly and a LCD panel. The major function of the backlight assembly is for providing the light source for the LCD display.

In general, the backlight assembly includes a plurality of cold cathode fluorescent lamps, a reflective housing, a diffusion plate, a diffusion film, and a brightness enhancement film. The cold cathode fluorescent lamps are used to generate the light. The reflective housing is used to reflect the light to the diffusion plate. The major function of the diffusion plate is used to diffuse the light from the cold cathode fluorescent lamps, in order to ensure further light illumination uniformity to the LCD panel, so as to reduce the non-uniform brightness phenomenon at the display surface of the LCD display. Because a plurality of diffusion particles is disposed in the diffusion plate, the transmittance of the diffusion plate is thereby decreased. Generally speaking, the transmittance of the diffusion plate is between 50% to 70%.

However, typically the use of the diffusion plate is not enough to overcome the non-uniform brightness phenomenon. Therefore, a diffusion film is needed to further diffuse the light. The diffusion film is an optical film having a plurality of diffusion particles thereon. In order to increase the illumination brightness within the various viewing angles, a brightness enhancement film is thereby added on the diffusion film.

Please refer to FIG. 1, FIG. 1 shows the front view of a brightness enhancement film 110. The brightness enhancement film 110 is mainly comprised of a base plate 111 and a structured layer 112. The thickness of the base plate 111 is about 175 μm. The material of the base plate 111 is transparent polyethylene terephthalate, hereinafter referred to as PET. Furthermore, additives are coated on the base plate 111. The thickness of the structured layer 112 is about 25 μm. The material of the structured layer 112 is photosensitive acrylic resin. The structured layer 112 is combined and joined with the base plate 111 by using the additives. Due to the prismatic microstructures on the structured layer 112, the brightness enhancement film 110 is able to condense the light. Consequently, the angle for the emergent light indicated as L₁ from the brightness enhancement film 110 will become narrowed, so as to increase the illumination brightness within the viewing angle range.

However, when the incident angle compared with respect to the brightness enhancement film 110 is much smaller, the light indicated as L₂ in FIG. 1 will be easily reflected by the structured layer 112. After being reflected, the length of the route segment of the light L₂ will be increased, and thus the illumination brightness of the light L₂ will be deteriorated. In order to solve this problem, some manufacturers added a plurality of diffusion particles in the structured layer 112, as shown in Taiwanese patent (patent No. 1301548).

However, adding diffusion particles in the structured layer 112 will increase the cost of manufacturing and materials. The diffusion particles are made of materials which have larger optical absorptivity than the structured layer 112, therefore, the diffusion particles would absorb more light, and thus the illumination brightness using the brightness enhancement film will be deteriorated. As a result, the method of adding diffusion particles in the structured layer 112 remains still at an experimental stage, and has not yet gone into mass production phase.

Hence, the inventor of this application provides an optical film which is able to avoid light having a smaller incident angle from being reflected by the structured layer, and thereby increase the illumination brightness and lower the manufacturing cost.

### SUMMARY OF THE INVENTION

One object of the present invention is to provide an optical film and manufacturing method thereof. The optical film can provide higher illumination brightness and has lower material cost.

To achieve the foregoing and other object, an optical film is disclosed. The optical film includes a main body and a plurality of first microstructures. In addition, a plurality of micro bubbles is distributed in the main body. The first microstructures are disposed on one side of the main body. Furthermore, the light would be condensed by the shape of the first microstructures.

To achieve the foregoing and other object, a manufacturing method of an optical film is provided, and the manufacturing method is described in the following text. First, a first curing glue is provided. The first curing glue is made by mixing together a photocurable resin and a thermosetting resin. The percent weight of the thermosetting resin is about 1%˜5% as compared to the weight of the curing glue as a whole. Then a plurality of micro bubbles in the first curing glue is formed. Thereafter, the first curing glue is illuminated by light emitting from a first light source. The first curing glue would be cured by the light and the heat irradiated from the first light source.

Next, a second curing glue is coated on the cured first curing glue. The second curing glue is made by mixing together the photocurable resin and the thermosetting resin. The percent weight of the thermosetting resin is about 1%˜5% as compared to the weight of the curing glue as a whole. Thereafter a plurality of first microstructures is formed on the second curing glue. The second curing glue is illuminated by the light emitting from a second light source. The second curing glue is cured by the light and the heat irradiated from the second light source. Thus the second curing glue and the first curing glue are combined into a primary optical sheet. The primary optical sheet is later divided into a plurality of optical films.

In the manufacturing method of an optical film, the light is condensed by the shape of the first microstructures.

After entering from the air (an optically thinner medium) to the optical film (an optically denser medium), the refractive angle of the light would be narrower than the incident angle. The distribution of the micro bubbles is at relatively high density in the optical film, and the refractive index of air inside these micro bubbles is about 1, thus after entering from the main body to the micro bubbles, the refractive angle of the light will be broader than the incident angle. Because of the micro bubbles, the light with narrower incident angles would have broader emergent angle. Hence, the light would more likely be deflected and concentrated from the two sides to the center of the first microstructures, and thus the illumination brightness using the optical film is increased.

The above and other aspects, features, and advantages of the present invention will become more apparent from the following detailed description when taken in conjunction with the accompanying drawings.

### BRIEF DESCRIPTION OF THE DRAWINGS

FIG. 1 shows the front view of a brightness enhancement film.

FIG. 2A shows an optical film of a first embodiment of the invention.

FIG. 2B shows an optical film of a second embodiment of the invention.

FIG. 3 shows the brightness comparison between using a traditional optical film and the optical film in the first embodiment.

FIG. 4 is a flow chart illustrating a manufacturing process of the optical film of the first embodiment.

FIG. 5A shows a front half portion of the manufacturing equipment for the optical film in the first embodiment.

FIG. 5A shows a front half portion of the manufacturing equipment for the optical film in the first embodiment.

FIG. 5B shows a later half portion of the manufacturing equipment for the optical film in the first embodiment.

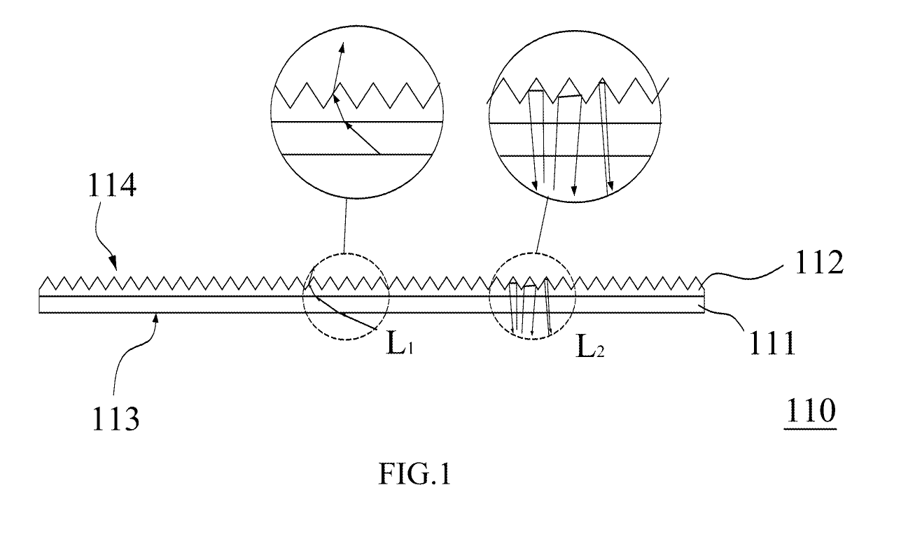

### DETAILED DESCRIPTION OF THE INVENTION

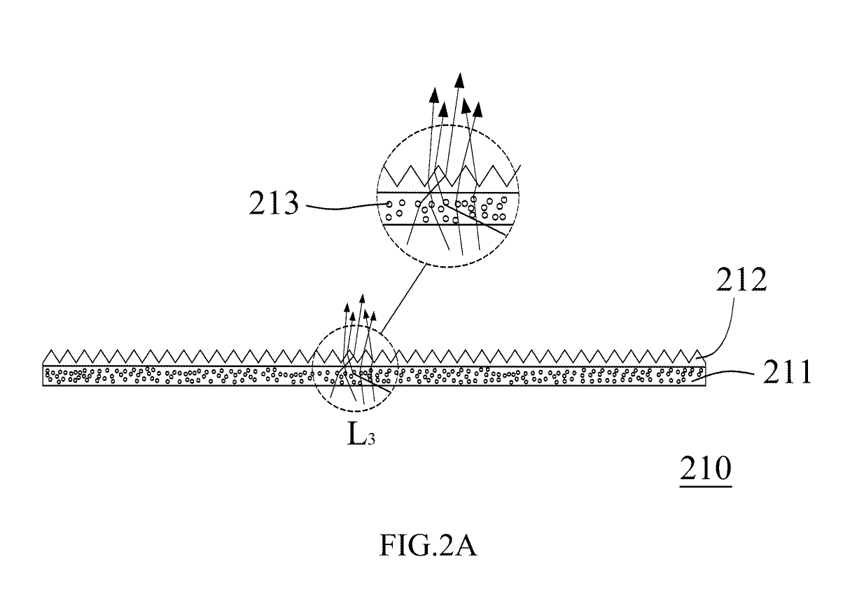

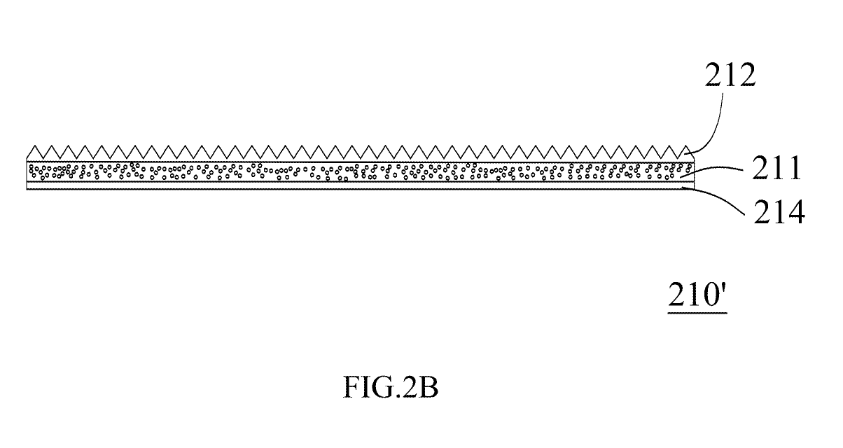

Please refer to FIG. 2A, FIG. 2A shows an optical film of a first embodiment in the invention. The optical film 210 includes a main body 211 and a plurality of first microstructures 212. The first microstructures 212 are disposed on one side of the main body 211. The shape of the first microstructure 212 is prismatic, thus the light passing through the first microstructures 212 would be condensed. Those skilled in the art can design the first microstructures in the form as other available shapes including, for example: lens-shape, pyramid, or any other shapes that can condense the light. Nevertheless, those skilled in the art can also design the first microstructure having shapes such as semi-spherical shape, trough shape, or other shape that can diffuse the light.

A plurality of micro bubbles 213 is disposed in the main body 211. In this embodiment, the average diameter of the micro bubble 213 is less than 10 μm, and preferably less than 2 μm. Furthermore, the distance between the neighboring micro bubbles 230 is desired to be as short as possible, preferably satisfied under the following equation: L<4 D. In this equation, D represents the average diameter of the micro bubble 213, and L represents the average distance between the neighboring micro bubbles 213.

Please refer to FIG. 2A, after entering from the air (optically thinner medium) to the optical film 210 (optically denser medium), the refractive angle of the light is narrower than the incident angle. Furthermore, the distribution of the micro bubbles 213 is at relatively high density in the optical film 210, and the refractive index of air inside the micro bubbles 213 is about 1. Thus, after entering from the main body 211 to the micro bubbles 213, the refractive angle of the light is broader or larger than the incident angle. Therefore, the light with the narrower incident angle would have broader emergent angle because of the micro bubbles. Hence, the light is more likely deflected and concentrated from the two sides to the center of the first microstructures, and thus the illumination brightness using the optical film 210 is increased. In other words, because of the micro bubbles 213, the light is less reflected by the first microstructures 212. Furthermore, compared to the optical film 110, the route segment of the light in the optical film 110 is shorter, thus the loss of the light will be reduced, and the illumination brightness using the optical film is increased.

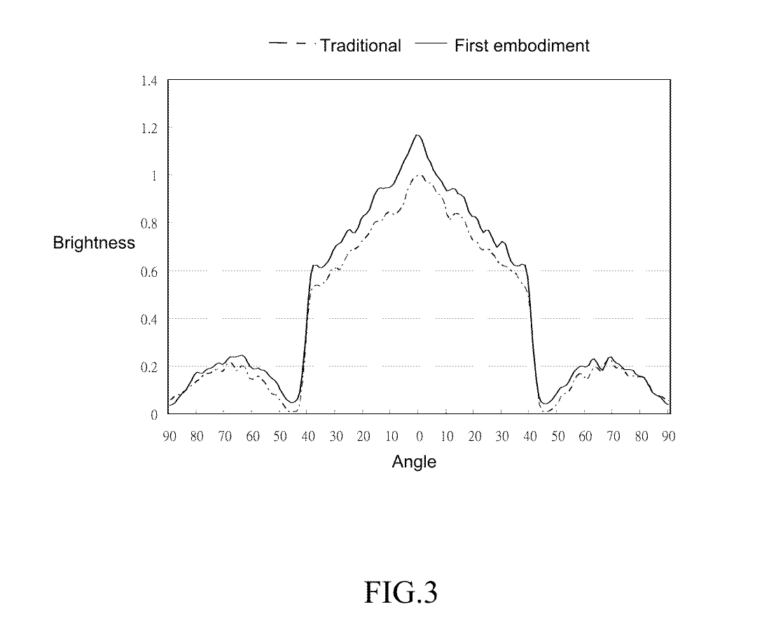

Please refer to FIG. 3, FIG. 3 shows the comparison of illumination brightness between using a traditional optical film and the optical film in the first embodiment. The brightness comparison performed is achieved by optical simulation. In this figure, the horizontal axis represents the angle, and the vertical axis represents the illumination brightness. The unit of the illumination brightness is represented by a dimensionless parameter, and the brightness using the traditional optical film 100 in a vertical viewing angle, i.e. 0 degree, is set as 1. From FIG. 3, those skilled in the art would understand and appreciate that the illumination brightness using the optical film 210 in the first embodiment is higher than the illumination brightness using the traditional optical film 110 throughout almost every possible viewing angle. Especially when viewed in the vertical viewing angle, the illumination brightness using the optical film 210 is 17% higher than that of the optical film 110.

One reason that the brightness of the optical film 210 is higher than the optical film 110 is not only that the micro bubbles 213 are distributed in the optical film 210, but also that there is no base plate found on the optical film 210. In the traditional optical film 110, the installation of the base plate causes the loss of the light. Compared to the method of adding the diffusion particles in the optical film (as shown as in TW 1305148), the medium inside the micro bubble 213 of the present embodiment is air, which has lower optical absorptivity, so that the loss of the light in the optical film 210 is thereby reduced. Furthermore, the manufacturing and material costs for micro bubbles 213 is lower than that for the diffusion particles.

Please refer to FIG. 2B, FIG. 2B shows the optical film of a second embodiment of the invention. The difference between an optical film 210′ in FIG. 2B and the optical film 210 in FIG. 2A is that the optical film 210′ further includes a hard coat layer 214. The hard coat layer 214 is placed on the side of and opposite to the first microstructures 212 of the main body 211. The material of the hard coat layer 214 is polymethyl methacrylate, polycarbonate, or ultraviolet glue. The hard coat layer 214 has higher hardness, so that the mechanical strength of the optical film 210′ as a whole is further enhanced. Furthermore, the hard coat layer 214 can have anti-static effect. In this embodiment, the hard coat layer 214 is made from a product with product number of CH-74003 of the CHWEN SHYANG ENTERPRISE CO., LTD in Taiwan.

Furthermore, a plurality of fluorescent powders can be added in the main body 211 of the optical film 210. The fluorescent powders are uniformly distributed in the main body 211. The fluorescent powders are yellow fluorescent powders, for example: yttrium aluminum garnet fluorescence powder. If the light source is a blue LED, a white ray will be produced when the yellow fluorescent powders is irradiated by the blue ray emitted from the blue LED.

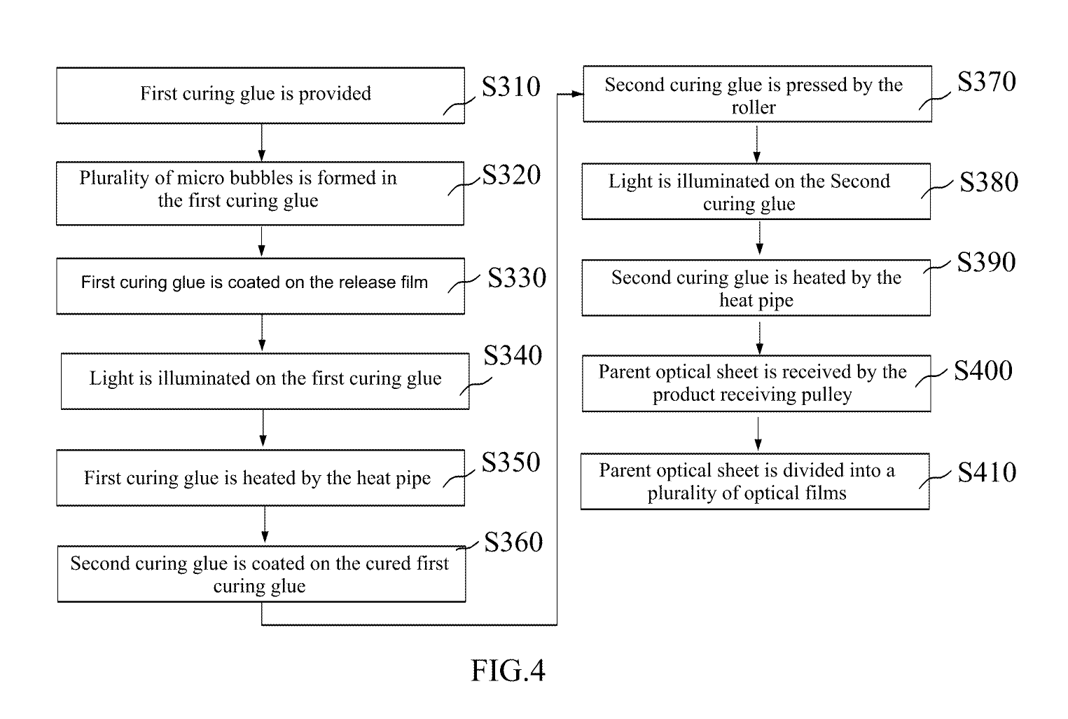

The manufacturing method of the optical film 210 in the first embodiment is described in the following text. Please refer to FIG. 4, FIG. 4 is a flow chart illustrating a manufacturing process of the optical film of the first embodiment. First, in step S310, a first curing glue is provided. The first curing glue is made by mixing together the photocurable resin and the thermosetting resin. The percent weight of the thermosetting resin is about 1%-5% when compared to the weight of the curing glue as a whole. Then, in step S320, a plurality of micro bubbles is formed in the first curing glue. The micro bubbles are formed, for instance, by heating the first curing glue and driving the gas into the curing glue. The method of driving gas into the first curing glue is executed by using a bubble machine. The diameter of the micro bubble can be adjusted by changing the settings on the bubble machine. If more micro bubbles are being driven into the first curing glue, the distance between the neighboring micro bubbles then becomes shorter. Or, by using the mixer, thereby the micro bubbles can be formed by mixing the first curing glue. After the micro bubbles are formed, the first curing glue is cooled into room temperature, and then the viscosity of the first curing glue is thereby increased. The viscosity of the cooled first curing glue is preferably above 250 cps, more preferably between 250 cps to 600 cps. Because of the viscosity of the first curing glue, the micro bubbles therein are not be easily leaked through the surface of the first curing glue. In this step, a person of ordinary skill in the art can add the fluorescent powders in the first curing glue.

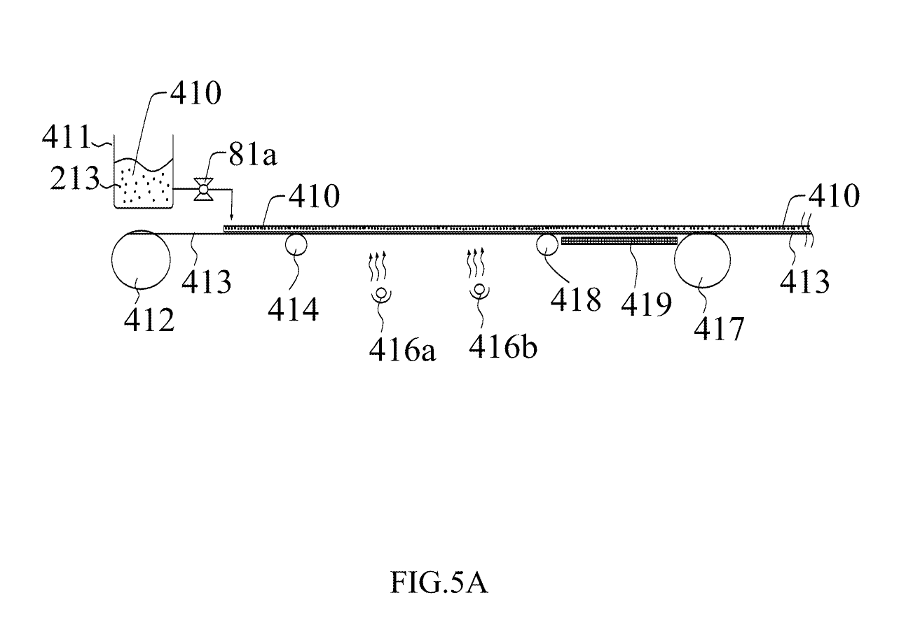

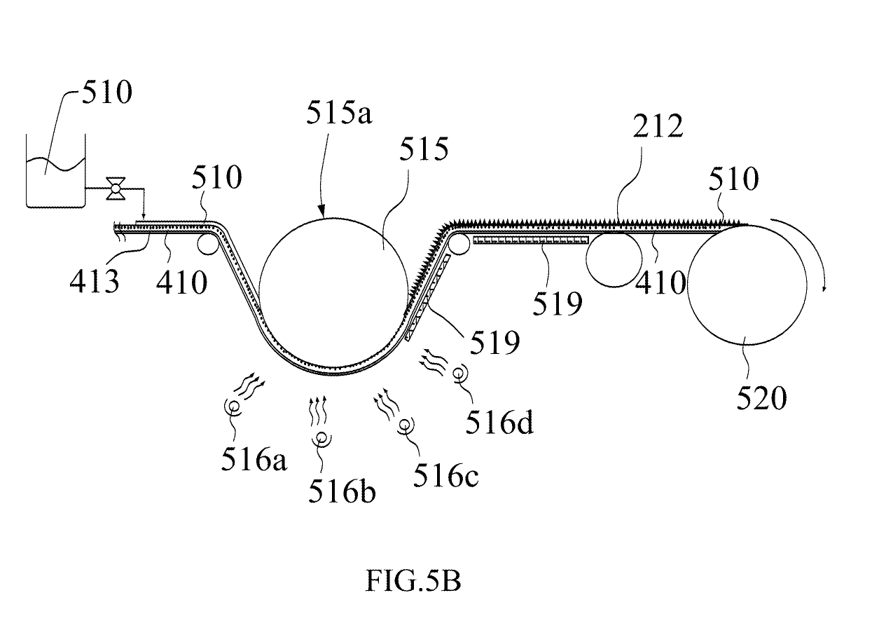

Thereafter, please refer to FIG. 4 and FIG. 5A, FIG. 5A shows a front half portion of the manufacturing equipment for the optical film in the first embodiment. The first curing glue 410, having the micro bubbles 213, is stored in a container 411. The container 411 includes a valve 81a. In step S330, the first curing glue 410 is coated on the release film 413. After the valve 81a is opened, the first curing glue 410 flows into the release film 413 via the valve 81a. The release film 413 is made of a transparent material, for example, polyethylene terephthalate, oriented polypropylene or other transparent material that would not crosslink with the first curing glue 410. Furthermore, a small amount of additives is coated on the release film 413, to allow the release film 413 to be adhered on the curing glue 410. The release film 413 is released from a releasing film roll 412 and is pulled forward by the auxiliary rollers 414, 417, 418. The auxiliary rollers 414, 417, 418 not only pull the release film 413, but also applies tension on the release film 413 to prevent the release film 413 from sagging downwards.

In step S340, the light, for example: an ultraviolet light, emitting from the first light sources 416a˜416b, is illuminated on the first curing glue 410. In step S350, the first curing glue 410 is transported above the heat pipe 419. The heat pipe 419 is placed between the auxiliary roller 418 and the auxiliary roller 417. After being illuminated by the light sources 416a˜416b and heated by the heat pipe 419, the first curing glue 410 would be cured. In this embodiment, step S350 is executed after step S340, but step 350 and step S340 can also be executed at the same time. The heat pipe 419 can also be replaced by other types of heat sources. For example, the first curing glue 410 can be dried by hot air. Furthermore, those skilled in the art can remove all heat sources because the light sources 416a˜416d themselves are able to heat the first curing glue by means of their thermal radiation.

Please refer to FIG. 4 and FIG. 5B, FIG. 5B shows a later half portion of the manufacturing equipment for the optical film in the first embodiment. In step S360, the second curing glue 510 is coated on the cured first curing glue 410. There is no micro bubble distributed in the second curing glue 510. The second curing glue 510 is made by mixing together the photocurable resin and the thermosetting resin, and the percent weight of the thermosetting resin is about 1%˜5% compared to the weight of the second curing glue 510 as a whole.

In step S370, a roller 515 comprising of pressed patterns (not shown) on its surface 515a is rolled on the second curing glue 510. In this embodiment, the pressed pattern is a depressed microstructure. After the second curing glue 510 is pressed by the roller 515, the pressed pattern would be transferred into the second curing glue 510, and then a plurality of first microstructures 212 is formed on the second curing glue 510.

In step S380, the light, for example: ultraviolet light, emitting from the second light source 516a˜516d is illuminated on the second curing glue 510. In this embodiment, steps S370 and S380 are executed at the same time. In step S390, the second curing glue 510 is transported above the heat pipe 519. After being illuminated by the second light sources 516a˜516d and heated by the heat pipe 519, the second curing glue 510 would be cured. In this embodiment, step S390 is executed after step S380, but step 390 and step S380 can also be executed at the same time. The heat pipe 519 can also be replaced by other types of heat sources. For example, the second curing glue 510 can be dried by hot air. Furthermore, those skilled in the art can remove all heat sources because the light sources 516a˜516d themselves are able to heat the first curing glue by their thermal radiation.

After step S380 and step S390, the cured second curing glue 510 and the first curing glue 410 are combined together into a primary optical sheet. In step S400, the primary optical sheet is received by the product rewind roll 520. Those skilled in the art can replace the product rewind roll 520 by other product receiving rewind roll feed apparatus that can receive the primary optical sheet.

In step S410, the primary optical sheet is taken down from the product rewind roll 520, and is divided into a plurality of optical films 210 shown in FIG. 2A. At the same time, the bottom of the optical film 210 is attached with the release film 413. The release film 413 and the optical film 210 are combined together by a small amount of additives, so that the release film 413 can be peeled away by a slight amount of force. In order to avoid the optical film 210 from being polluted from the surroundings during the period of transportation and storage, the release film 413 would not be torn or peeled off until the optical film 210 is in usage. Furthermore, during the transportation and storage, a protective film 210 would be attached on top of the optical film 210 to protect the first microstructures 212 thereon.

The manufacturing processes between the optical film 210′ shown in FIG. 2B and the optical film 210 shown in FIG. 2A are similar, but except for some differences. One major difference is that in step S330, the first curing glue 410 is coated on a substantially flat and cured hard coat sheet. The hard coat sheet is placed on the release film. After the hard coat sheet is cut and divided, the hard coat layer 214 is formed.

The materials of the first curing glue 410 and the second curing glue 510 are described in the following text. The first curing glue 410 and the second curing glue 510 are made by mixing together the photocurable resin and the thermosetting resin. Herein, the photocurable resin is cured when it is illuminated by light at a specified range of wavelength band. In this embodiment, the photocurable resin is an UV curable resin, which is cured after being illuminated by ultraviolet radiation.

The UV curable resin is widely used because of its beneficial characteristics, such as for example, higher toughness, easy to forming, and convenient to processing. The UV curable resin is mainly comprised of oligomers, for example, polyester acrylic oligomer, epoxy acrylic oligomer, or polyurethane acrylic oligomer. Furthermore, a reactive monomer and a photo initiator can be added into the UV curable resin, in order to improve the performance characteristics and reaction rate of the UV curable resin. The thermosetting resin is made for example of polyester or polyurethane.

Although the description above contains many specifics, these are merely provided to illustrate the invention and should not be construed as limitations of the invention's scope. Thus it will be apparent to those skilled, in the art that various modifications and variations can be made in the system and processes of the present invention without departing from the spirit or scope of the invention.

What is claimed is:

1. An optical film, comprising:
a main body, inside which a plurality of micro bubbles is distributed; and
a plurality of first microstructures, disposed on one side of the main body.

2. The optical film of claim 1, wherein the light is condensed by the shape of the first microstructures.

3. The optical film of claim 1, further comprises a hard coat layer, wherein the hard coat layer is disposed on the opposite side of the main body as compared to the side of the main body comprising the first microstructures.

4. The optical film of claim 1, wherein the optical film is made of a curing glue, the curing glue is made by mixing together the photocurable resin and the thermosetting resin, and the percent weight of the thermosetting resin is about 1%˜5% compared to the weight of the curing glue as a whole.

5. The optical film of claim 4, wherein the photocurable resin is an UV curing resin.

6. The optical film of claim 4, wherein the thermosetting resin is selected from the group consisting of polyester or polyurethane.

7. The optical film of claim 1, wherein the average diameter of the micro bubbles is less than 10 μm.

8. The optical film of claim 1, wherein the shape of the first microstructures is prismatic.

9. The optical film of claim 1, wherein the average distance between the neighboring micro bubbles is less than 4 times the average diameter of the micro bubbles.

10. The optical film of claim 1, wherein a plurality of fluorescent powder is disposed in the main body.

11. The optical film of claim 1, wherein the fluorescent powder is yttrium aluminum garnet fluorescence powder.

12. A manufacturing method of an optical film, comprising:
providing a first curing glue, which is made by mixing together a photocurable resin and a thermosetting resin, and the percent weight of the thermosetting resin being about 1%˜5% compared to the weight of the first curing glue as a whole;
forming a plurality of micro bubbles in the first curing glue;
illuminating the first curing glue by a first light source, and the first curing glue being cured by the light and the heat irradiated by the first light source;
coating a second curing glue on the cured first curing glue, the second curing glue being made by mixing together the photocurable resin and the thermosetting resin, and the percent weight of the thermosetting resin being about 1%˜5% compared to the weight of the second curing glue as a whole;
forming a plurality of first microstructures on the second curing glue;
illuminating the second curing glue by a second light source, the second curing glue being cured by the light and the heat irradiated by the second light source, and combining the second curing glue and the first curing glue into a primary optical sheet; and
dividing the primary optical sheet into a plurality of optical films.

13. The manufacturing method of claim 12, wherein the photocurable resin is an UV curing resin.

14. The manufacturing method of claim 12, wherein the viscosity of the uncured first or second curing glue is above 250 cps.

15. The manufacturing method of claim 12, wherein the viscosity of the uncured first or second curing glue is between 250 cps to 600 cps.

16. The manufacturing method of claim 12, further comprising:
heating the first curing glue and the second curing glue by a heat source after the first microstructures are formed.

17. The manufacturing method of claim 16, wherein the heat source is a heat pipe.

18. The manufacturing method of claim 12, wherein the thermosetting resin is selected from the group consisting of polyester and polyurethane.

19. The manufacturing method of claim 12, wherein the average diameter of the micro bubbles is less than 10 μm.

20. The manufacturing method or claim 12, wherein the average distance between the neighboring micro bubbles is less than 4 times the average diameter of the micro bubbles.
